(19) United States
(12) Patent Application Publication
(10) Pub. No.: US 2013/0314740 A1
(43) Pub. Date: Nov. 28, 2013

(54) PRINTER

(71) Applicants: Jordi Arnabat Benedicto, L'Arboc del Penedes Tarragona (ES); Jan Morovic, Colchester (GB); Benjamin Jules Millner, Sant Cugat del Valles Barcelona (ES); Eva Blay Lerin, (US); Oscar Martinez Bailac, Castelldefels BCN (ES)

(72) Inventors: Jordi Arnabat Benedicto, L'Arboc del Penedes Tarragona (ES); Jan Morovic, Colchester (GB); Benjamin Jules Millner, Sant Cugat del Valles Barcelona (ES); Eva Blay Lerin, (US); Oscar Martinez Bailac, Castelldefels BCN (ES)

(21) Appl. No.: 13/480,718

(22) Filed: May 25, 2012

(51) Int. Cl. G06K 15/02

(52) U.S. Cl. 358/1.15; 358/1.16

(57) ABSTRACT

A printer is provided comprising a storage section arranged to store medium profile information; and a communication section arranged to obtain the medium profile information via a network, wherein the communication section is further arranged to communicate the medium profile information to an image processing section.

### BACKGROUND

In image processing and printing an image to be printed may be processed by a raster image processor (RIP) prior to printing. One function of the RIP is to convert the image from the color space of the input image to the color space of the printer. To obtain good results it is preferable for the processing to take into account the medium or substrate (herein medium and substrate are used interchangeably) on which the image is to be printed, as even with media of similar types there may be important differences between the media properties.

### BRIEF DESCRIPTION OF THE DRAWINGS

Embodiments of the invention are further described hereinafter with reference to the accompanying drawings, in which:

FIG. 1 shows an example of a printer.

FIG. 2 shows an example of a system including the printer of FIG. 1.

FIG. 3 is a flow chart illustrating an example of a method performed by the printer of FIG. 1.

FIG. 4 is a flow chart illustrating an example of a method performed by an image processing device in the system of FIG. 2.

### DETAILED DESCRIPTION

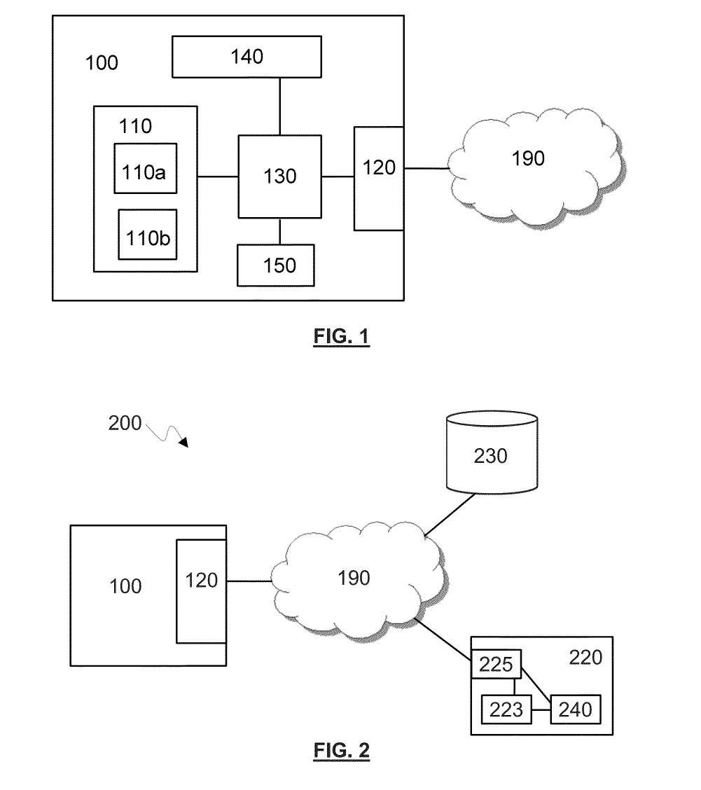

FIG. 1 shows a printer 100 having a storage section 110, a communication section 120, a control section 130 and a document processing section 140, arranged to apply an image to a print medium. The communication section 120 is arranged to allow communication between the printer 100 and other devices. The communication with other devices may be achieved via connection to one or more networks, and additionally or alternatively via direct connection to one or more devices. The communication section 120 of FIG. 1 is shown connected to network 190. Communication may be via electrical wiring, fire optic wiring, wireless signals, etc. The type of network 190 is not particularly limited, and may include one or more of a personal area network, local area network, wide area network, campus area network, metropolitan area network or the Internet, for example. The network 190 may include wired and/or wireless connections.

Storage section 110 may include any storage media, such as volatile storage, non-volatile storage or a combination thereof. Storage section 110 may store medium profile information 110a indicative of properties of a medium. In some examples the storage section 110 may store resource location information 110b indicative of an external source of medium profile information. The resource location information 110b may include, for example, one or more Uniform Resource Locators (URLs), one or more Internet Protocol (IP) addresses, etc.

The control section 130 controls the various sections of the printer 100 and performs processing tasks. The control section may include a processor or combination of processors, software, firmware, etc. The control section 130 may include a computer-readable storage medium with computer executable instructions stored thereon operable when executed to cause the printer to operate as described herein. The computer-readable storage medium may be non-volatile.

The document processing section 140 may include a print module, such as an ink jet print module, a laser printing module, etc. The document processing section 140 may also include medium handling elements to control movement of a medium through the document processing section 140.

The printer may include a user interface 150, such as a control panel or front panel. In some examples the user interface is a touch screen.

FIG. 2 shows a system 200 including the printer 100 of FIG. 1. The system includes a medium profile resource 230 connected to the printer 100 via network 190. The system also includes an image processing section 220 connected to the printer 100 via the network 190. In some examples the image processing section 220 may be connected directly to the communication section 120 of the printer 100, rather than being connected to the communication section 120 via network 190. The image processing section 220 may include a communication module 225 to enable the image processing section 220 to communicate with external devices (e.g. printer 100) directly and/or via a network 190.

In some examples the image profile resource 230 may be directly connected to the communication section 120 of the printer 100, rather than being connected to the communication section 120 via a network 190.

The medium profile resource 230 includes a storage section arranged to store a plurality of medium profiles and a communication section to allow communication with the printer 100. The storage section may be a database or lookup table, and may be accessible via a network (such as the Internet.) The storage section 110 of the printer 100 may store location information 110b to enable the printer 100 to communicate with the medium profile resource 230 via communication section 120. For example, location information 110b may include an IP address, a URL, etc. and it is to be understood that “location” in this context may refer to a network location, rather than a geographical location. The storage section 110 may also store other information for communicating with the profile resource 230, such as account details, passwords, etc. A plurality of medium profile resources 230 may be provided; these may each store identical information, or may store different information. The storage section 110 may include the location of one or more of such medium profile resources 230. The medium profiles may each be associated with a specific medium type, or associated with a group of medium types (e.g. with similar properties). The medium profile may also depend on the printer.

Printer 100 is arranged to receive an input indicating a medium type, such as a paper type. The input medium type may indicate a type of medium loaded in the printer 100. The medium type may include one or more of a manufacturer, brand name, product code, etc. The input may be performed by a user via the user interface, for example. In some examples, the user input of the medium type is used to perform an incremental search to provide suggested matching media during input of the medium type by the user. The search may be performed over medium profiles stored by the medium profile resource 230 and the processing associated with the search may be performed by a processing section associated with the medium profile resource 230. In some examples the search may be based on media profiles stored by the storage section 110 of the printer 100 instead of, or as well as, medium profiles stored by the medium profile resource 230. In some examples the medium profile resource includes an http-application programming interface (API) to enable information to be downloaded from the medium profile resource. In such examples the API may also be arranged to enable upload of medium profile information to the medium profile resource 230, and/or to enable query/search of the medium profile information.

Where the printer 100 storage section 110 does not have medium profile information corresponding to the input medium type, the communication section 120 obtains medium profile information from the medium profile resource 230, and the obtained medium profile information is stored by the storage section 110. In some examples, the control section 130 may determine that the printer 100 storage section 110 has medium profile information corresponding to the input medium type, but that medium profile resource 230 has an updated or preferable version. In this case, the control section 130 may cause the communication section to obtain the updated or preferable version of the medium profile information from the medium profile resource 230, and cause this profile information to be stored by the storage section 110 instead of, or as well as, the profile information previously stored by the storage section 110

According to this example, the printer 100 stores information 110b (such as location information) to allow the printer 100 to communicate with the medium profile resource 230. Accordingly, the user is not required to know a location of the medium profile resource 230, and obtaining new medium profiles at the printer 100 occurs transparently. Furthermore, as the printer 100 obtains the medium profiles, this can be achieved using information provided directly to the printer, such as by a user identifying a medium product code when loading the medium to the document processing section 140.

According to some examples, little or no user interaction is required during the process of obtaining and storing the medium profiles, as this may be performed automatically by the printer 100 under control of the control section 130.

In some examples the control section 130 may include a medium profile generation module. The control section 130 may receive input from the user interface 150 of the printer providing information on parameters associated with a medium. A medium profile may then be generated based on the user input. In some examples medium profile information generated by the medium profile generation module may be uploaded to the medium profile resource 230, and may be made available to other users and/or printers.

The image processing section 220 obtains the medium profile information from the printer 100 via the communication section 120. The image processing section 220 may then store the medium profile information using a storage module 223. Alternatively, the image processing section 220 may obtain the medium profile information each time it is to be used. In some examples the image processing section 220 requests the medium profile information from the printer 100. In some examples the printer 100 is arranged to push medium profile information to the image processing section 220, for example periodically or when new image profile is received by the printer 100.

The image processing section includes an image generation section 240 arranged to receive an input image for printing and to format the input image to generate an output image in a format suitable for printing by the printer 100. The input image may be received via the communication module 225 or via a user interface module (not shown). The image processing section 220 may perform a color-space transformation from the color-space of the input image to the color-space of the printer. The image processing section 220 may also, or alternatively, determine printing parameters and provide them to the printer 100, such parameters may include print resolution, number of passes, curing temperature, vacuum level, paper advance settings, etc. The output image (possibly including one more of the printing parameters) is generated based on the medium profile information.

The image processing section 220 provides the processed image and any printing parameters to the printer 100. The control section 130 of the printer 100 causes the document processing section 140 to apply the received image to a print medium, in accordance with any printing parameters received from the image processing section 220.

According to this example the medium profile information may be independent of the type of image processing section 220. This reduces or eliminates the need for different versions of the medium profile information to be prepared for different types of image processing section, which may improve interoperability, and reduce costs and outlay of resources compared to providing a plurality of medium profiles that are specific to the image processing section 220. In addition, it may simplify obtaining medium profile information from a user's point of view.

According to this example, the image processing section 220 obtains the medium profile information from the printer 100. Accordingly, the processing of the input image may be based on properties of the medium on which the image is to be printed while neither a user nor the image processing section 220 needs to be aware of the location of the medium profile repository 230. Furthermore, it is not necessary to manually obtain the medium profile information. In some examples the image processing section 220 may be arranged to automatically process the medium profile information, such that manual installation of the medium profile information in the processing section 220 is not required.

In some examples the image processing section 220 is a Raster Image Processor (RIP). The RIP may, for example, be embodied in software, hardware or a combination thereof. The RIP may be a dedicated device or may be a module of a device that also performs other functions, for example the RIP device may generate the input image.

The medium profile information may include color profile information, the color profile information providing sufficient information for the image processing section 220 to take the medium properties into account when converting from the color space of the input image to the color space of the printer. In some examples the color profile information includes an ICC profile. Printer parameters associated with the print medium (e.g. parameters that achieve optimal print quality, such as curing temperature, paper advance speed, vacuum level, number of passes, etc.) may be included in the medium profile information. The printer parameters may be provided in XML format, for example. Appendix 1 shows an example of printer parameters provided in XML format.

Where the image processing section 220 is a RIP, the medium profile information may be RIP agnostic (i.e. independent to the RIP with which it is to be used) and the RIP may be arranged to generate a RIP-specific resource based on the medium profile. Thus, a RIP-specific resource may be automatically generated without requiring a user to manually enter a large number of parameters. Manual entry of parameters is particularly inconvenient when RIPs are inconsistent in the manner of generating RIP-specific resources, e.g. using different parameters and workflows, particularly where the parameters to be input are selected from a large number of possible parameters, resulting in difficulty for a user attempting to tune to obtain the best image quality. Accordingly, this example does not require a user to have in depth knowledge of printing parameters or the workflow of the RIP in question in order to provide a medium resource in the RIP.

According to some examples the printer 100 provides a web service arranged to provide notifications when resource information has changed (e.g. created, set up, edited or deleted). The image processing section 220 may include a client to the web service, such that the image processing section 220 is notified of modifications to the medium profile information 110a stored by the printer 100. When the client provided in the image processing section 220 is notified of modifications, the image processing section may automatically obtain the modified medium profile information. In some examples the user may be prompted to confirm that the modifications should be obtained and/or used. In some examples the modified medium profile information is obtained without user interaction or with little user interaction.

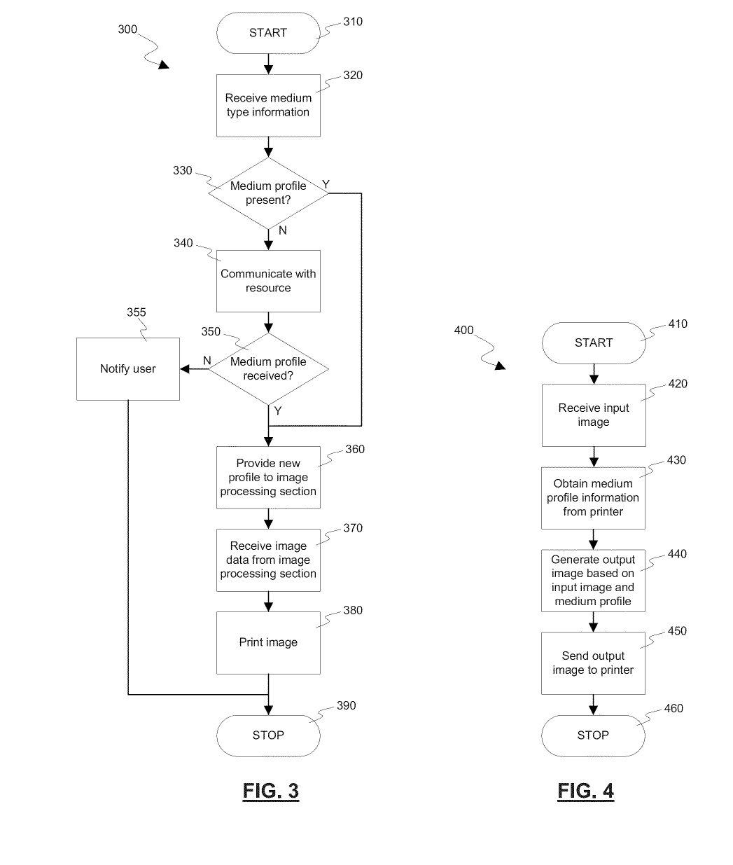

In some examples a method performed by a printer includes obtaining medium profile information associated with a medium type and providing the medium profile information to an image processing section 220 (e.g. a raster image processor, RIP, device). An example of such a method is shown in FIG. 3.

The method 300 of FIG. 3 starts at step 310. At step 320 the printer receives an input indicative of a medium type. The input may be from a user via a user interface section, for example, and may include one or more of a product code, a product name, a manufacturer name, etc. The printer determines 330 whether it has medium profile information associated with the indicated medium. When it is determined that the printer has the medium profile information, the method moves to step 360. When it is determined that the printer does not have the medium profile the printer communicates 340 with a profile resource. For example, the printer 100 may use resource location information 110b stored in storage section 110 to request medium profile information from the medium profile resource 230. The request may include the information input by the user identifying the medium type. Communication with the medium profile resource 230 may include user interaction via the user interface 150 of the printer, such as selecting a medium type from a set of medium types matching the identifying information. If it is determined 350 that medium profile information associated with the medium type is stored by the medium profile resource 230, the medium profile information is communicated to the printer 100, and may be stored by storage section 110, and the method moves to step 360. When medium profile information associated with the medium type is not stored by the medium profile resource 230, the printer may inform 355 the user accordingly via the user interface 150 and the process may then terminate 390.

In step 360 newly received medium profile information is provided to the image processing section 220. This may include the printer 100 receiving a request for the medium profile information from the image processing section 220 via communication section 120, and responding to the request. In some examples the printer 100 may push newly obtained medium profile information to the image processing section 220, for example, this may be done periodically, when new profile information is obtained, or when a new image processing section 120 communicates with the printer 100.

The printer 100 may receive image data 370 from the image processing section 220, where the image data has been processed by the image processing section 220 based on the medium profile information.

The image may be printed by the printer 100 at step 380 based on the image data received from the image processing section 220. The process then terminates at step 390.

In some examples, when no medium profile is available, step 355 may be replaced by selecting alternative medium profile information and continuing the method at step 360 (or possibly at step 370 where the image processing section 220 has previously stored the alternative medium profile information). For example, a medium profile for a similar medium may be used, or a generic profile may be used. The selection of the alternative profile may be performed by the printer 100, by the medium profile resource 230, or by the user. In some examples, when no medium profile is available, the user may be given an option generate their own medium profile information using the user interface 150 of the printer 100.

In some examples, when the control section 130 receives an indication that a new type of medium has been provided to the printer 100 (e.g. via input by a user via the user interface 150) the printer 100 communicates with the medium profile resource 230. The user may identify the medium type using the user interface 150, and this may be communicated to the medium profile resource 230 to conduct a search. In some examples an incremental search may be used, wherein the search results and/or suggested matches are provided to the user in real time via the user interface 150 during entry of information on the type of medium by the user via the user interface 150.

In some examples the printer 100 obtains all medium profile information from the medium profile resource and stores the medium profile information in storage section 110, such that obtaining medium profile information is not necessarily performed, or not necessarily performed only, in response to entry of a medium type. In some examples the printer 100 communicates with the medium profile periodically to determine whether profile information has been updated. In some examples the medium profile resource 230 may inform the printer 100 when medium profile information has been updated in the medium profile resource 230. In some examples updated profile information may be automatically obtained by the printer 100 from the medium profile resource 230.

According to an example, the image processing section 220 obtains medium profile information from a printer 100, and an image generation section 240 generates an output image based on an input image and the medium profile information, and provides the output image to the printer. FIG. 4 shows an example of a method 400 performed by the image processing section 220. The method begins at step 410. The image processing section 220 receives 420 an input image. In some examples, the input image may be received from another device (such as a computer) via communication module 225. In some examples the image processing section includes a user interface module, and the input image may be produced from user input to the user interface module.

The image processing section 220 obtains 430 medium profile information from the printer 100. In some examples the image processing section 220 requests the medium profile information and receives the medium profile information in response. In some examples the printer 100 provides medium profile information to the image processing section 220 without a request being sent to the printer 100, for example by the printer 100 sending the medium profile information periodically or when the medium profile information available to the printer 100 is updated.

The image processing section 220 generates 440 an output image based on the input image, and based on the medium profile information 220. For example, the image processing section 220 may perform a color-space conversion from a color space of the input image to a color space of the printer 100. Also, or in addition, the output image may include information specifying printing parameters, such as print resolution, number of passes, curing temperature, vacuum level, paper advance settings, etc. The output image is provided 450 to the printer 100 for printing, and the process terminates at step 460.

It should be noted that references herein to “automatic” processes indicate that a bulk of the process is carried out without user intervention. As used herein, “automatic” does not exclude processes that are initiated by the user, but performed thereafter with little or no user interaction. Furthermore, it should be noted that such processes need not exclude all user interaction. For example, an automatic process may involve a superficial level of user interaction, such as requesting a user to confirm whether or not a process should proceed (e.g. when a file is to be overwritten.)

The sections and modules described herein may include various components, such as hardware and software components. Such components

may be shared between different sections and modules, and may perform other functions.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments.

What is claimed is

1. A printer comprising:
a storage section to store medium profile information; and
a communication section to obtain the medium profile information via a network, wherein
the communication section is further to communicate the medium profile information to an image processing section, and to receive image data from the image processing section.

2. The printer of claim 1, wherein the communication section is further to receive, from the image processing section, image data formatted in accordance with the medium profile information.

3. The printer of claim 1, wherein the communication section is to automatically obtain the medium profile information in response to an input to the printer identifying a medium type.

4. The printer of claim 1, wherein the image processing section is a raster image processor.

5. The printer of claim 1, wherein the image processing section is external to the printer.

6. The printer of claim 1, wherein the medium profile information is independent of a type of the image processing section.

7. The printer of claim 1, wherein the communication section is to receive a request for the medium profile information from the image processing section; and
wherein the communication section is to communicate the medium profile information to the image processing section in response to the request.

8. The printer of claim 1, further comprising an input section to receive input from a user, wherein:
the control section includes a medium profile generation module to receive parameters associated with the medium, and to generate the medium profile based on the received parameters.

9. The printer of claim 1, wherein the communication section is to upload the generated medium profile to a medium profile resource.

10. A non-transitory computer-readable storage medium with computer executable instructions stored thereon operable when executed to cause a printer to operate as a printer comprising:
a storage section to store medium profile information; and
a communication section to obtain the medium profile information via a network, wherein
the communication section is further to communicate the medium profile information to an image processing section, and to receive image data from the image processing section.

11. A method comprising:
obtaining, by a printer, medium profile information associated with a medium type via a network;
providing, by the printer, the medium profile information to an image processing device; and
receiving, by the printer, image data from the image processing device.

12. The method of claim 11, further comprising the printer receiving, from the image processing device, image data formatted in accordance with the medium profile information.

13. The method of claim 11, wherein the obtaining is performed automatically by the printer in response to an input to the printer identifying the medium type.

14. The method of claim 11, wherein the image processing device is a raster image processor, RIP, device.
